(19) United States
(12) Patent Application Publication
(10) Pub. No.: US 2026/0087246 A1
(43) Pub. Date: Mar. 26, 2026

(54) DATA EXTRACTION SYSTEM AND METHOD

(71) Applicant: CDO Consulting, LLC, New York, NY (US)

(72) Inventors: Catherine D. O'Dwyer, New York, NY (US); Smit Chandrasinh Parmar, Lower Parel (IN); Mrugank B. Sharma, Lower Parel (IN)

(21) Appl. No.: 19/294,711

(22) Filed: Aug. 8, 2025

Related U.S. Application Data
(60) Provisional application No. 63/698,770, filed on Sep. 25, 2024.

(51) Int. Cl. G06F 40/186; G06F 16/25; G06F 40/177; G06F 40/205

(52) U.S. Cl. CPC G06F 40/186; G06F 16/254; G06F 40/177; G06F 40/205

(57) ABSTRACT

A data extraction system and method that provides a reliable, automated alternative to the manual input of financial and other data from portable document format (PDF) documents. The solution of the present disclosure, for example, utilizes an extraction template to parse through each page of the PDF document to identify relevant data elements based on the position relative to other field names shown in the PDF document. Because the data incorporates the actual digital values from the PDF objects (as opposed to an interpreted value from an OCR analysis) the numerical values are processed with a high level of confidence and accuracy.

### CROSS REFERENCE TO RELATED APPLICATION

This application claims priority to U.S. Provisional Patent Application No. 63/698,770, filed Sep. 25, 2024, entitled “DATA EXTRACTION SYSTEM AND METHOD,” the contents of which are expressly incorporated herein by reference in its entirety.

### BACKGROUND

Data extraction from certain PDF reports that contain financial (numeric) information continues to be a very manual process. In many businesses, including tax and accounting, the data is extracted by manual data entry methods which are labor-intensive and subject to human error.

For example, investors with holdings in private investments may receive a U.S. Schedule K-1 tax form (form 1065) at least once a year, with several dozen fields that must be incorporated into the investor's periodic tax calculations and filings. This data includes the name and tax id of the investor, the name and tax id of the investment entity, ordinary income and expenses, dividends, distributions, deductions and many other data items related to the activity of the investment for the tax year. All of this information must be entered into any tax calculation system for tax estimates and preparation.

While the K-1 tax form is a standardized form designed by the IRS, the data in the digital version of the PDF can be presented in very different digital formats depending on the source of the electronic PDF file. Thus, the visual appearance of the document provides no understanding as to how the data is electronically organized in the digital file. In addition, the K-1 form includes graphic images, in the form of checkboxes, which are critical elements of the tax-related data. The collection of these graphical elements is another key part of the data extraction process.

These issues described above are not unique to K-1 tax documents. There are many other types of tax documents that present a large amount of information, mainly numerical values, which require the entry and incorporation of the reported data into an investor's tax reporting. Examples of these other forms include the Schedule K-3 which is often included along with the K-1 tax form, the various 1099 forms and the W-2 form. Yet further, investors may receive financial statements with balance and/or performance information in PDF form which, while in standard formats, must be manually input into accounting and reporting systems.

Finally, the problems of extracting data from forms is not limited to tax and accounting forms. Many other types of forms include data that is manually extracted because conventional methods, such optical character recognition (OCR), fail to accurately recognize data on the forms. Such forms include, but are not limited to, purchase orders, travel and expense forms, invoices, insurance forms, medical forms, etc.

Thus, there is a need for an improved system and method to accurately extract data from forms in an automated manner.

### SUMMARY

The present disclosure describes methods and systems for data extraction that provides a reliable, automated alternative to the manual input of financial and other data from portable document format (PDF) documents. The solution of the present disclosure, for example, utilizes an extraction template to parse through each page of the PDF document to identify relevant data elements based on the position relative to other field names shown in the PDF document. Because the data incorporates the actual digital values from the PDF objects (as opposed to an interpreted value from an OCR analysis) the numerical values are processed with a high level of confidence and accuracy.

The data extraction is accomplished through several steps, as described below in greater detail. Initially, the extraction template is constructed. The extraction template is then used to extract data quickly and accurately from any PDF document with a common structure and data labels. The PDF document is broken down into regions (data groups) that are identified by pre-determined text terms that constrain the region from which the desired data will be extracted. This template can also be tested on a set of “test PDFs” and refined to capture common variations.

After the extraction template for the specific type of PDF document is created, the template can be applied to any number of such PDF documents. A user may load any number of documents that are in the format of the extraction template and process all these documents in one batch, collecting and storing the defined data fields from each document. Additionally or optionally, this data can then be reviewed and/or extracted.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 illustrates an example flow diagram of operations performed to create an extraction template according to certain embodiments;

FIGS. 2-8, 9A and 9B illustrate example user interfaces associated with the operational flow of FIG. 1 according to certain embodiments;

FIG. 10 illustrates an example of a completed extraction template according to certain embodiments;

FIG. 11 illustrates an example operational flow diagram of an extraction template processing process according to certain embodiments;

FIGS. 12-17 illustrate example user interfaces associated with the operational flow of FIG. 11 according to certain embodiments;

FIG. 18 illustrates an example operational flow diagram of an extracted data review process according to certain embodiments;

FIG. 19 illustrates an example user interface associated with the operational flow of FIG. 18 according to certain embodiments;

FIG. 20 illustrates an example matrix and checkbox configuration operational flow diagram according to certain embodiments; and

FIG. 21 is a schematic diagram of computer hardware that may be utilized to implement event notification processing in accordance with the disclosure according to certain embodiments.

### DETAILED DESCRIPTION

### Overview

An issue with data in PDF documents is that it is organized into a grid of pixels with coordinates x and y. While the data may look clear from a visual perspective, the arrangement from a digital perspective can vary significantly across documents produced by different sources. Documents that look identical may have different margins, positioning, and resolution. Text and values in a document that appear to be in the same position may appear in a variety of formats in the PDF data. Even one number may occur as multiple objects in the file. As a result, most PDF data extraction solutions use OCR to collect the pixelized data and convert it to textual data. This is generally effective for text-heavy documents but works less effectively for numerical data and particularly for numerical data in tables. In addition, text extraction tools using OCR can improve their results significantly by applying language and contextual filters to correct errors in converting the scanned image to text. This is not an option for most numerical data, which often have limited data validation options. For example, a 1 that is misidentified as a 7 is a critical error and is unlikely to be identified as such.

The data extraction systems and methods described herein provide a reliable, automated alternative to the manual input of data from PDF documents, which is commonly used to address the above issue. The solution utilizes an extraction template to parse through each page of the PDF document and then identify the relevant data elements based on the position relative to other field names shown in the PDF document. Because the data incorporates the actual digital values from the PDF objects (as opposed to an interpreted value from an OCR analysis) the numerical values are processed with a high level of confidence and accuracy.

The data extraction may be accomplished through the following steps. Initially, an extraction template is constructed that may be used to extract data quickly and accurately from any PDF with a common structure and data labels. In an example, the PDF document is broken down into regions (e.g., data groups) that are identified by pre-determined text terms that constrain the region from which the desired data or textual notes will be extracted. In the example below, four such text terms are utilized. The text terms define the upper, lower, left and right boundaries of a rectangular region. By segmenting the PDF document into small regions, the data in each region is limited to a small set of data (e.g., such as a single box in a table), which leads to significant improvements in the accuracy in identifying the data elements. In some implementations, the extraction template may be tested on a set of “test PDFs” and refined to capture common variations. The number of test PDFs can be just a few or hundreds, depending on the complexity of the PDF format.

Because this method divides a PDF document into rectangular regions, it is particularly effective for tax documents that use a consistent table-like format, such as, but not limited to the K-1 form. It is noted that the method is not limited to tax documents and can be applied to any document that presents information in a standard structure with labels or headers identifying and orienting the data on the page, even if the order of the information or sizing of the tables is not consistent.

Once an extraction template is created, any PDF document or portion of a PDF document that is in the format of this extraction template can be processed and the data extracted with a high level of accuracy. Thus, creating the extraction template may occur at any time prior to applying the extraction template to the specific type of PDF document once the specific type of PDF document is known. The extraction template may be made available to end users for later application through any distribution methods and media. Users are able to load any number of PDF documents that are in the format of the extraction template and process the documents by collecting and storing the data points, as defined by the extraction template, from each document. This data can then be reviewed for accuracy and/or exported for use in other systems.

The extraction template is not limited to being constructed and processed for a single document. For example, the extraction template can be applied multiple times for a single pdf document which consists of multiple pages with multiple tables. The method can use a similar identification text to identify the sub-sections of the document where the extraction template should be applied. This identification can be through a page number or a table title. Using a similar concept of constraint texts, this segmentation of a multi-page document into relevant sub-documents enables the extraction template to be applied to each table or section of the pdf.

### Extraction Template Construction

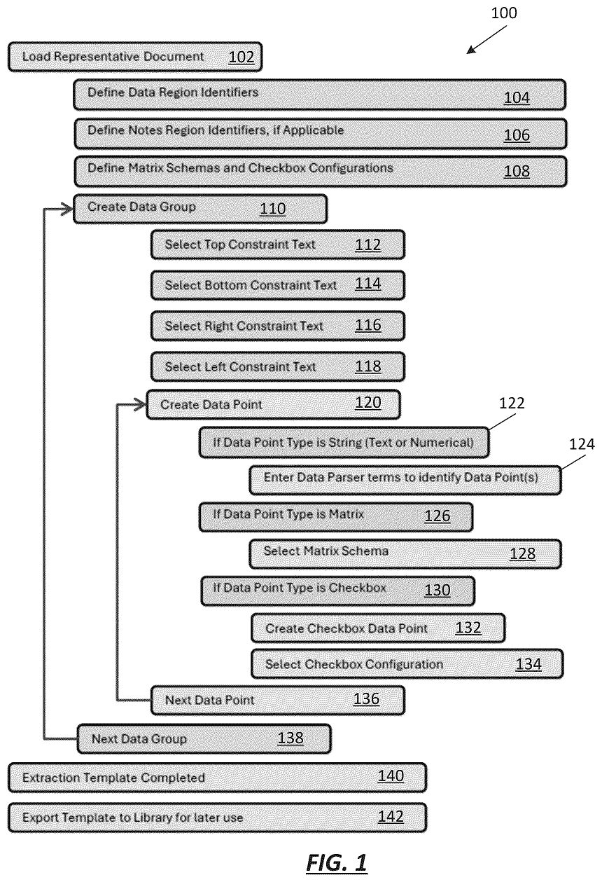

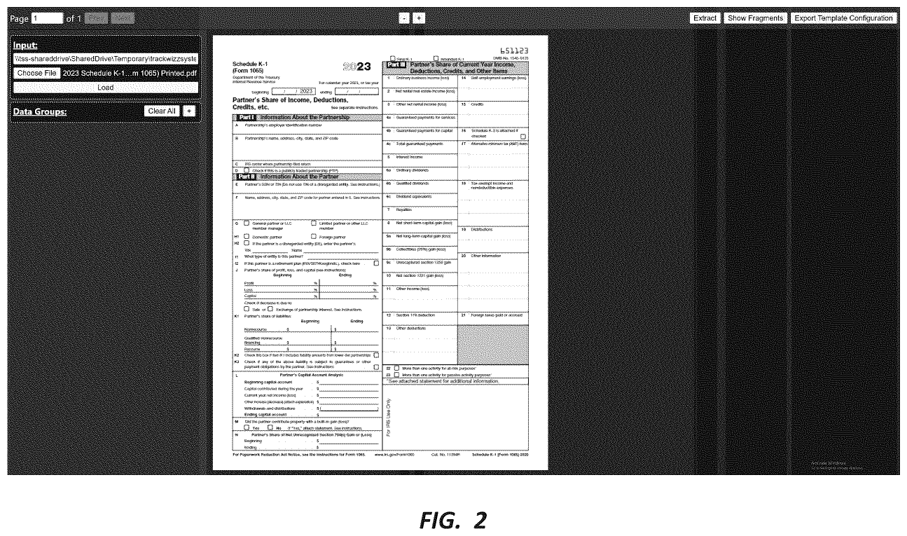

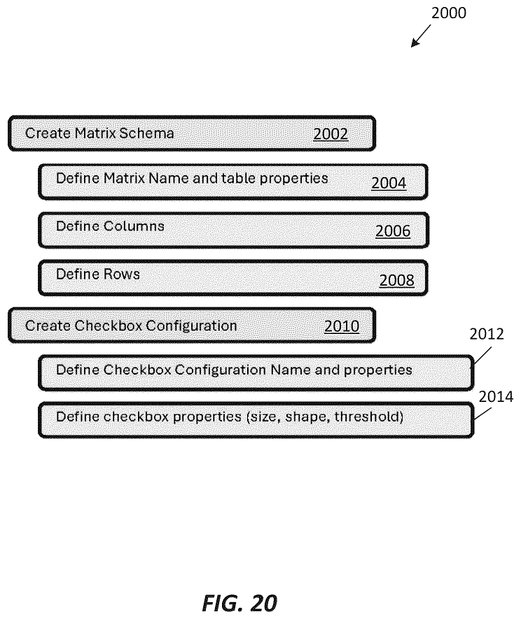

With reference to FIG. 1, there is illustrated an example operational flow diagram 100 of an extraction template construction process in accordance with aspects of the disclosure. At 102, a representative document is loaded into a template construction component 2121, which then displays the document using a document display component 2122, as shown in FIG. 2. This representative document is used as the basis for identifying each region and creating the extraction template. At 104, data region identifiers are defined. For example, a text field collection component 2123 collects the text fields that can be potentially selected to define the data regions. At 106, “Notes” region identifiers are defined. If the region is flagged as a “Notes” region, then text may be disregarded for purposes of template construction. At 108, matrix schemas and checkbox configurations are created. Additional details of this process is described below with reference to FIG. 20.

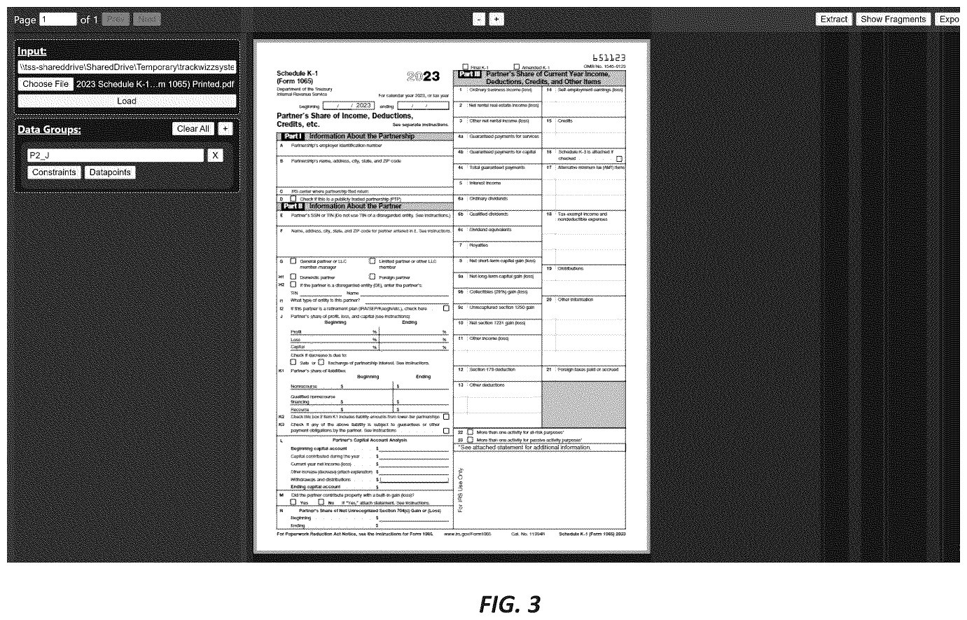

At 110, new data groups are then created. As shown in FIG. 3, a single region is contained in each data group. Each data group may consist of four text fields that define a rectangular region on the representative document that are stored as data group data 2131. Additional or fewer text fields may be used to define regions of all geometric shapes on the representative document.

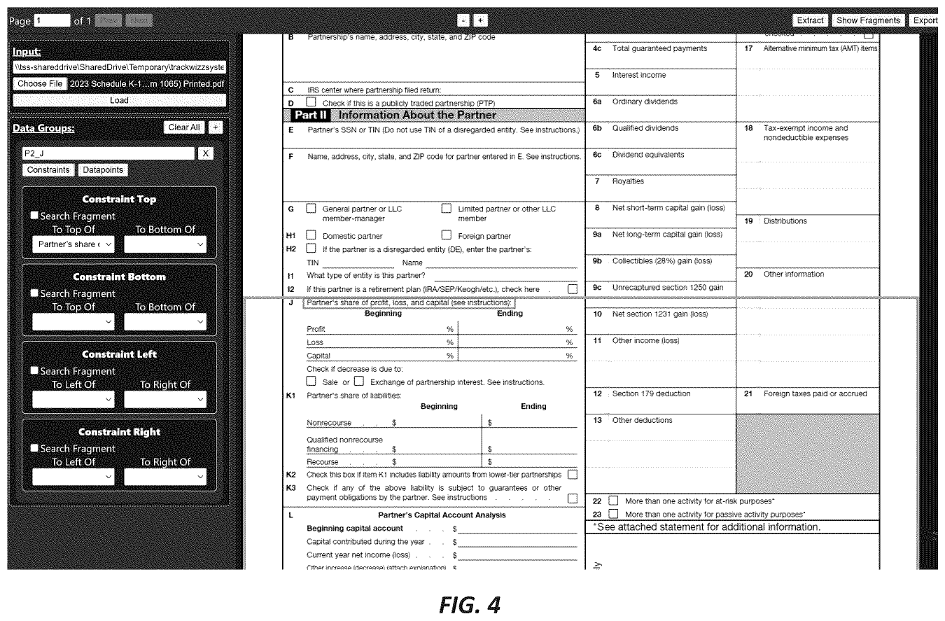

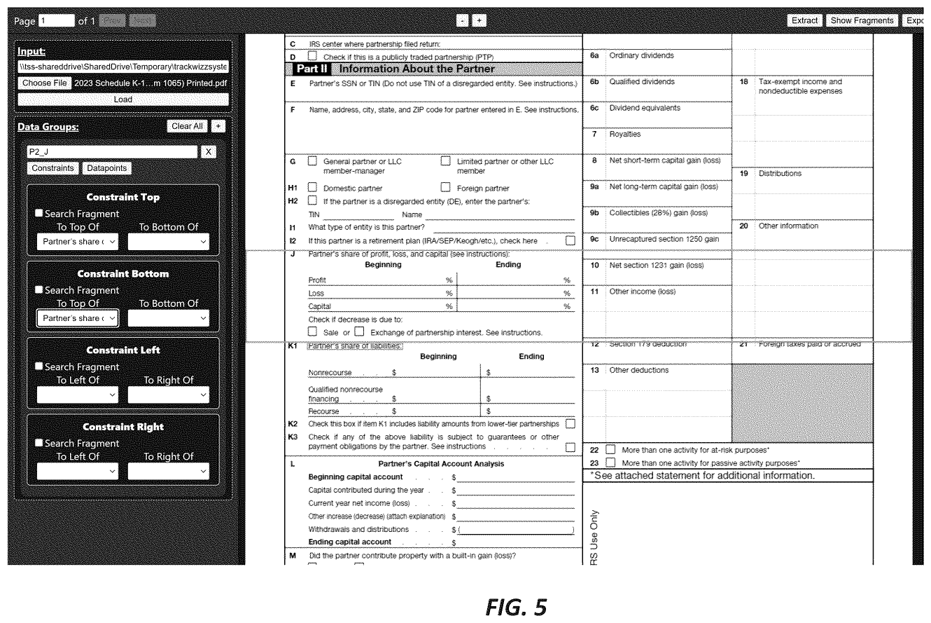

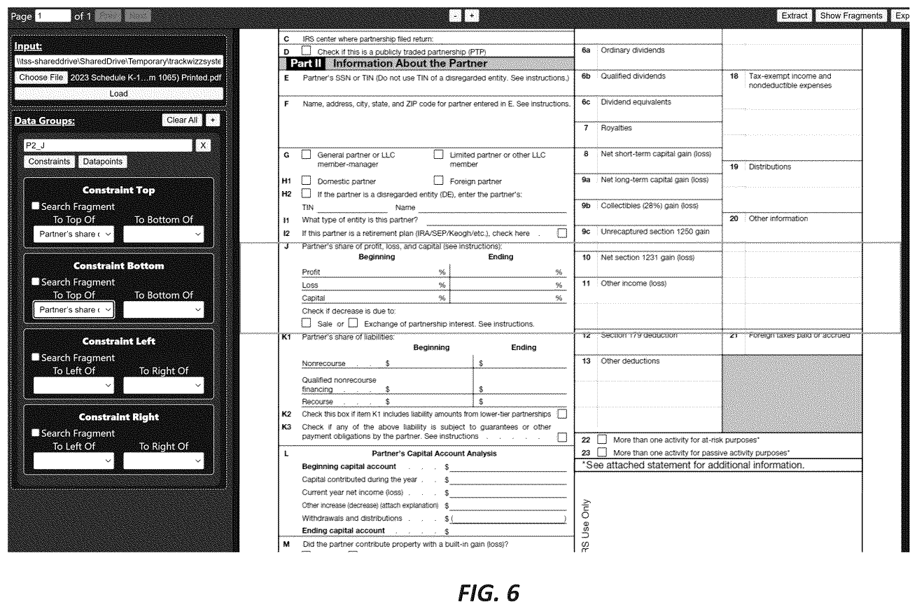

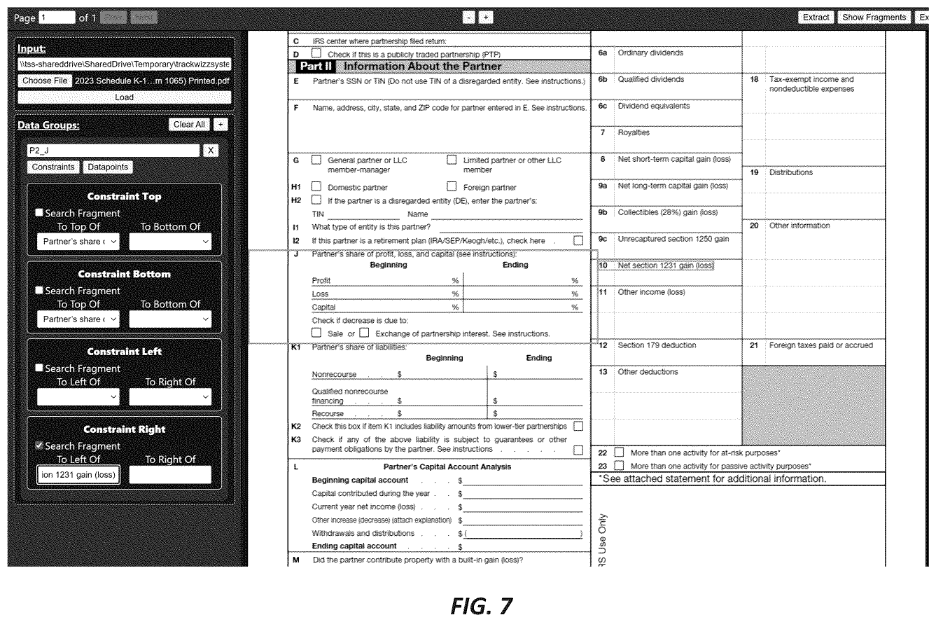

The template construction component 2121 enables the user to select specific text strings (e.g., constraint texts) and what side of the text box will be used in defining the region. The constraints are stored as constraint data 2132. If a rectangular region is to be defined, there may be four constraint texts to identify at 112, 114, 116 and 118 and as shown in FIGS. 4-7:

| | | |
|---|---|---|
| Constraint | Constraint text | Text box side selection |

| | |
|---|---|
| Top | Top of or bottom of |
| Bottom | Top of or bottom of |
| Left | Left of or right of |
| Right | Left of or right of |

The template construction component 2121 then displays the region on the representative document that is described by this data group. If one constraint is not defined, it applies the default value that corresponds to the relevant edge of the PDF document (top, bottom, left, or right edge). The data group may be provided with a name to assist in managing the regions. There can be any number of regions in the template depending on the complexity of the document format.

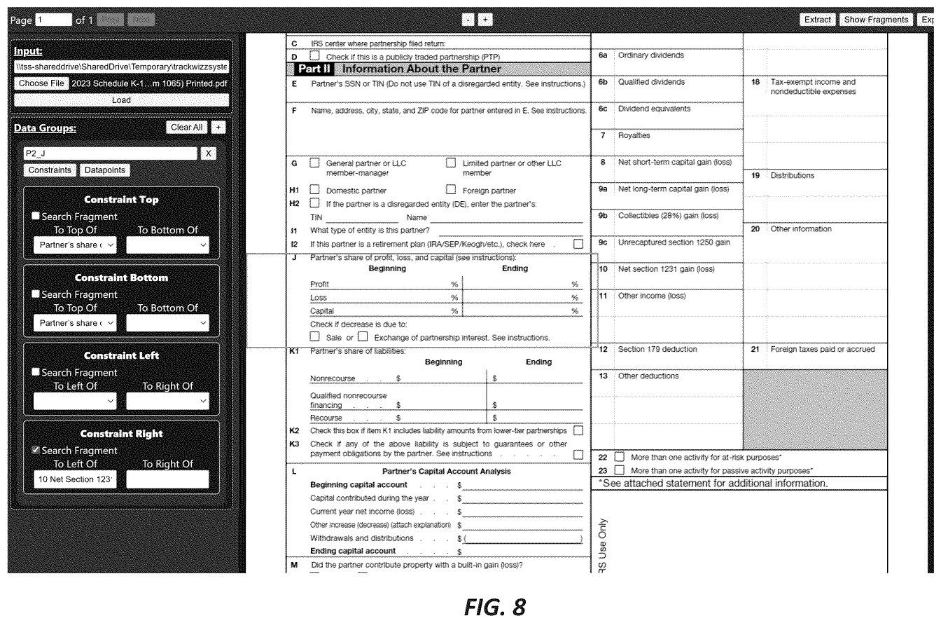

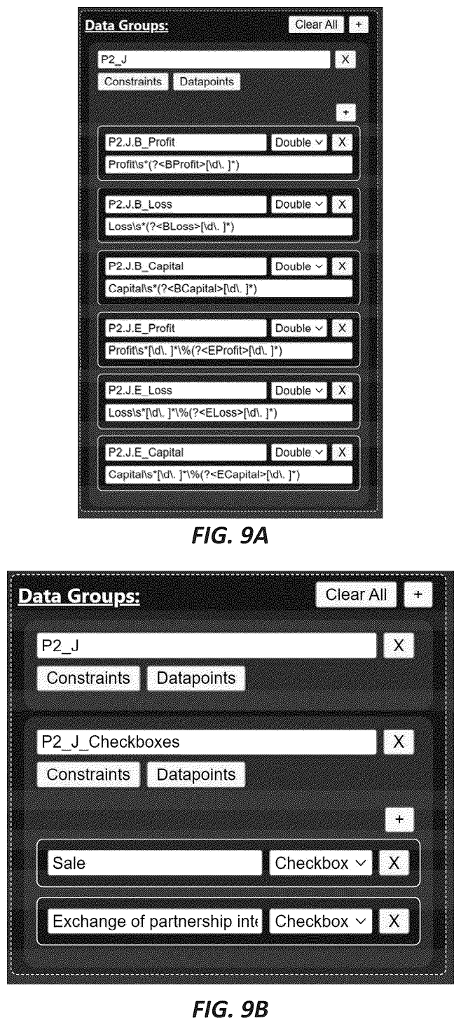

At 120-136, each data group is further defined to contain specific data fields (datapoints). These data fields can be easily identified from the region's text values because of the limited scope of the region, as shown in FIG. 8. The datapoints that are text or values are extracted from the region's text using standard PDF conversion and parsing tools, as shown in FIG. 9A, and are stored as datapoint data 2133. Below are example definitions of the datapoints.

| Datapoint | Datatype | Regex Pattern |
|---|---|---|
| P2.J.B_Profit | Double | Profit\s*(<BProfit>[\d\. ]*) |
| P2.J.B_Loss | Double | Loss\s*(<BLoss>[\d\. ]*) |
| P2.J.B_Capital | Double | Capital\s*(<BCapital>[\d\. ]*) |
| P2.J.E_Profit | Double | Profit\s*\%[\d\. ]*(<EProfit>[\d\. ]*) |
| P2.J.E_Loss | Double | Loss\s*\%[\d\. ]*(<ELoss>[\d\. ]*) |
| P2.J.E_Capital | Double | Capital\s*\%[\d\. ]*(<ECapital>[\d\. ]*) |

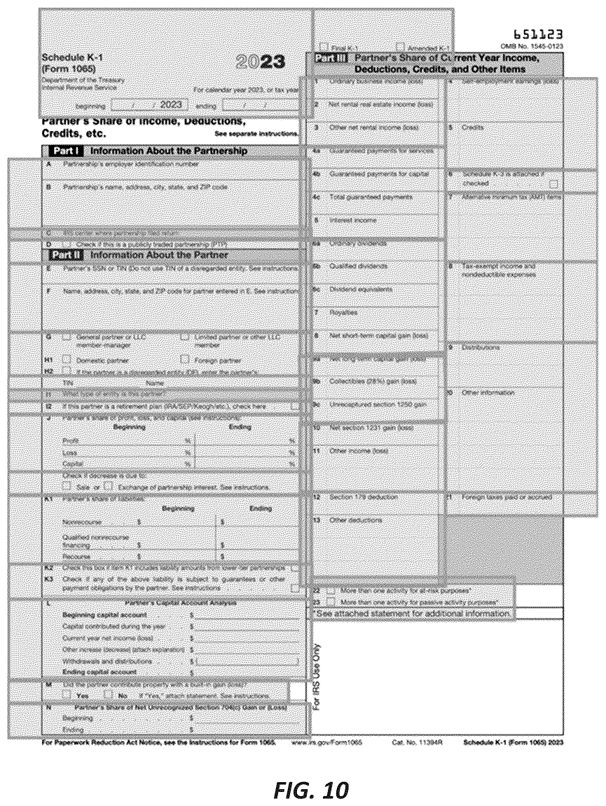

With reference to FIG. 9B, the datapoints that are graphical images, such as checkboxes, can be extracted using a standard image processing tool. The check box is determined to be checked based on the density of the pixels with the defined box. For example, the processing tool may find a “box” image and count black pixels within image to determine checked (True) or unchecked (False). There can be one or more datapoints in each region, but it is preferrable to only have a few datapoints in each region. The datapoint can also be of a type “Matrix”, which represents a two-dimensional table, with columns and rows defined by Column and Row Labels. This allows for tables that span multiple pages in the pdf document. It also provides additional validation options across the rows or columns of the datapoint object. At 138, a next region data group, if any, is created as described above. Once all desired region groups are defined, then at 140, the extraction template construction process is complete. An example is shown in FIG. 10. At 142, the extraction template is exported to a library and stored as extraction template data 2134 for use in template processing, as described below.

### Extraction Template Processing

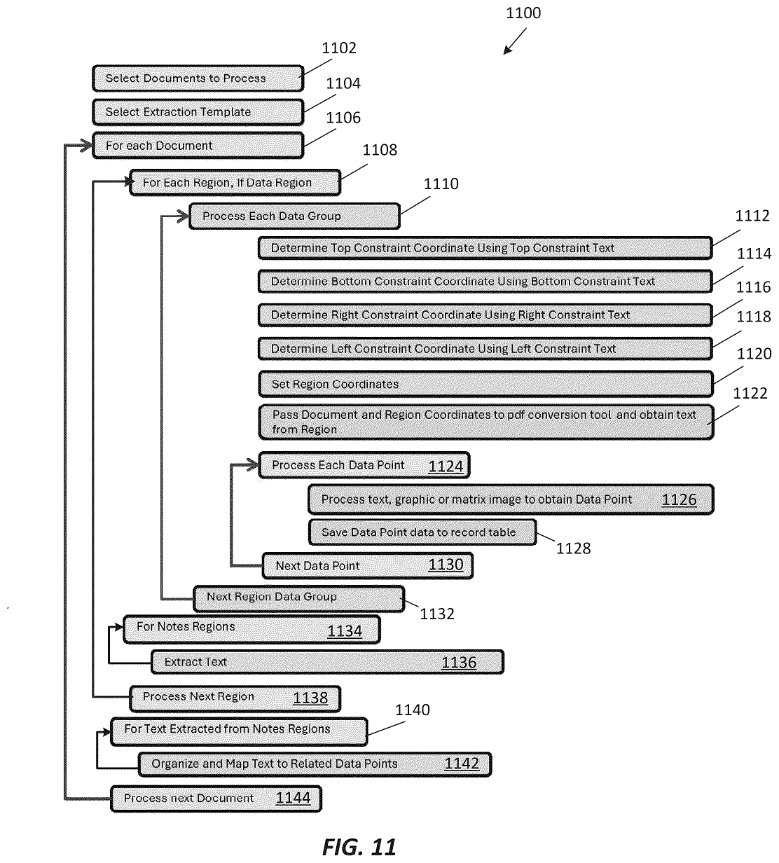

As noted above, once an extraction template is constructed, it can be applied to any number of selected PDF documents that have a structure to which it applies. With reference to FIG. 11, there is illustrated an example operational flow diagram 1100 of an extraction template processing process in accordance with aspects of the disclosure. Each PDF may be processed using the extraction template as follows:

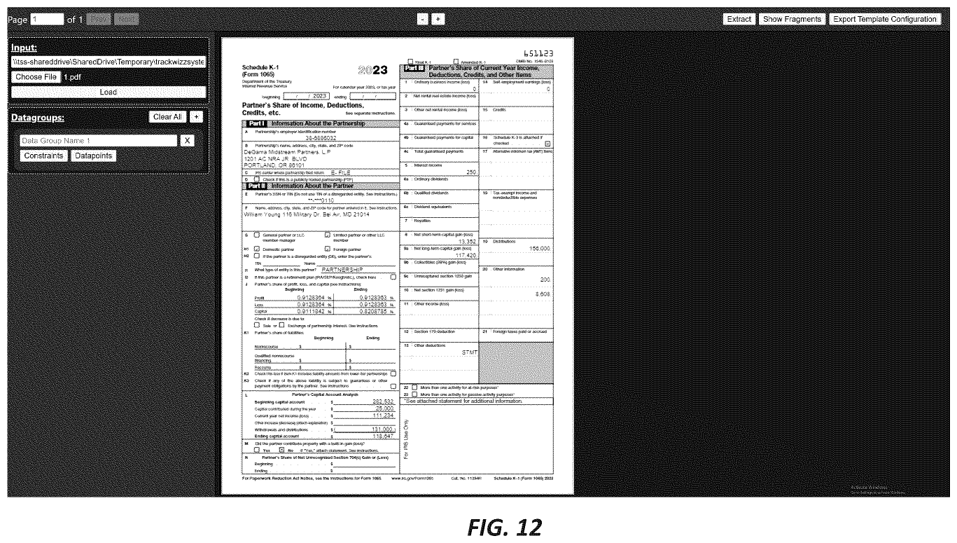

At 1102, a user selects the PDF document(s) to be loaded into a document processing component 2124. An example is shown in FIG. 12. At 1104, the user selects the extraction template to apply to the documents. At 1106, for each document, the document processing component 2124 processes the document using the selected extraction template according to the following:

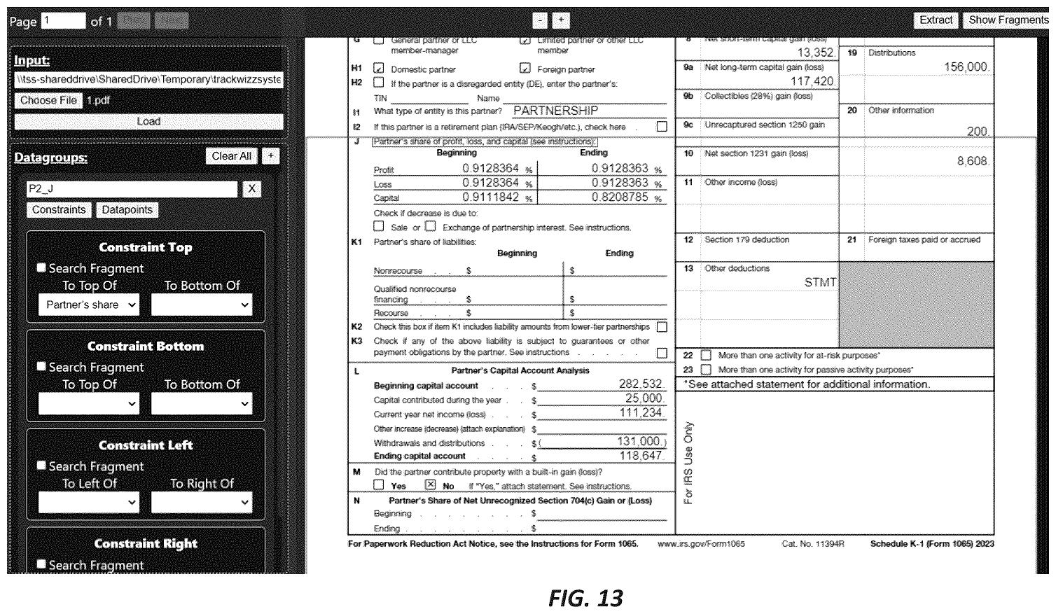

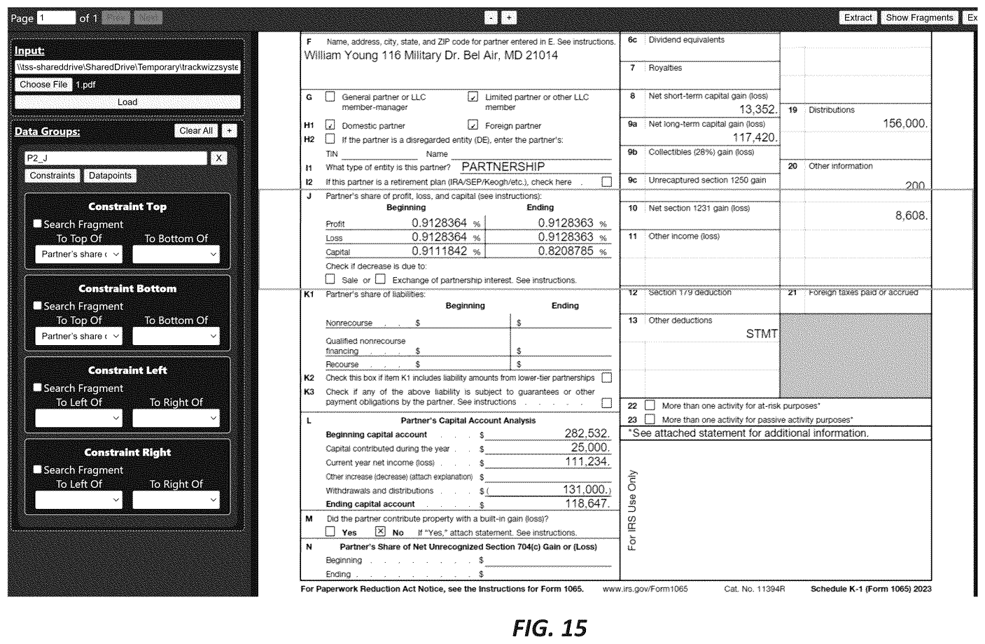

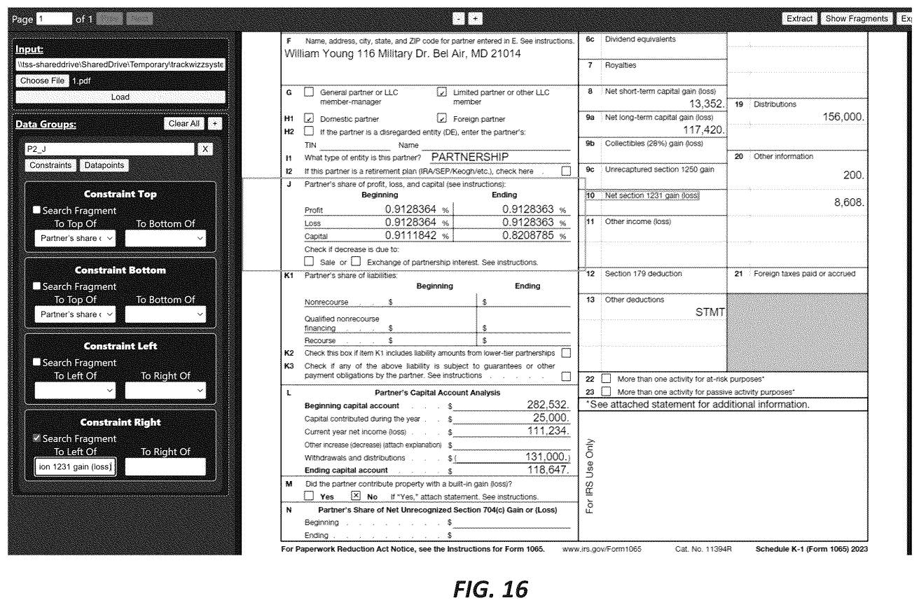

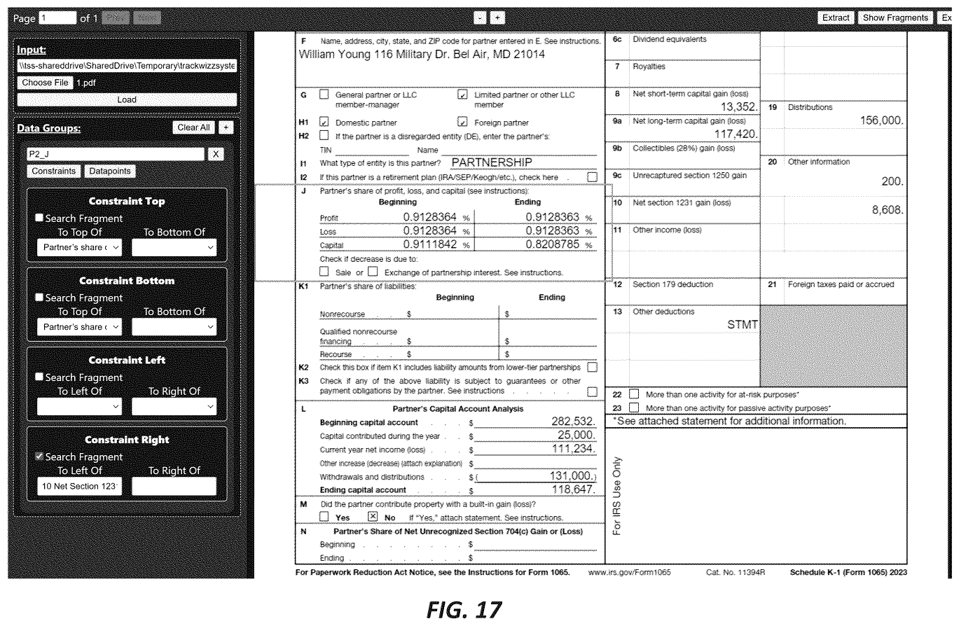

At 1108, each region is processed, wherein at 1110 each data group is processed, where for each border constraint, the constraint text in the document is found (at 1112, 1114, 1116 and 1118) and using the constraint properties (e.g., top, bottom, left and right coordinates), identify the relevant coordinate in the document for the constraint side. Examples are shown in FIGS. 13-16. Once this is completed for all four sides of the rectangle, the region in the document is set at 1120. Next, at 1122, the text for the selected region is processed by passing the region coordinates and the document to a PDF converter. Checkboxes and matrix gridlines may be processed through an image processing tool. An example is shown in FIG. 17.

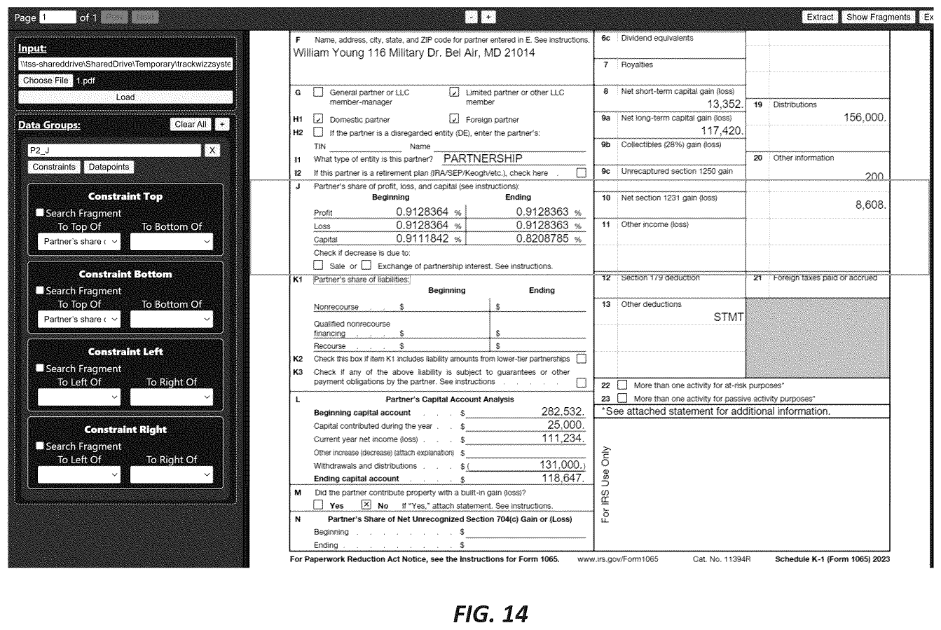

The text is then parsed at 1124-1130 to extract the desired datapoints per instructions in the data group. In the examples shown FIGS. 14-16, the extracted data points are, for example:

$$P 2 \cdot J \cdot B\_Profit = 0.4638219 \%$$

$$P 2 \cdot J \cdot B\_Loss = 0.4638219 \%$$

$$P 2 \cdot J \cdot B\_Capital = 0.4561842 \%$$

$$P 2 \cdot J \cdot E\_Profit = 0.4638218 \%$$

$$P 2 \cdot J \cdot E\_Loss = 0.4 638 \; 218 \%$$

$$P 2 \cdot J \cdot E\_Capital = 0.3208785 \%$$

Data points checkbox rules are also applied and the data values are extracted and saved. For example:

$$P 2 \cdot J \cdot B\_Sales = FALSE$$

$$P 2 \cdot J \cdot B\_Exch = FALSE$$

Data points matrix schema are applied based on Column and Row Labels, and such data is extracted into the two-dimensional matrix data point. An example of such a matrix schema is below

| | | (a) U.S. | | (b) Foreign | | (c) Passive | | (d) General | | | | | |
|---|---|---|---|---|---|---|---|---|---|---|---|---|---|
| Gross Income | (1, 1) | Source | (2, 1) | branch | (3, 1) | Income | (4, 1) | Income | (5, 1) | (e) Other | (6, 1) | (g) Total | (7, 1) |

| | | | | | | | |
|---|---|---|---|---|---|---|---|
| Sales | (1, 2) | (2, 2) | (3, 2) | (4, 2) | (5, 2) | (6, 2) | (7, 2) |
| Performance of Services | (1, 3) | (2, 3) | (3, 3) | (4, 3) | (5, 3) | (6, 3) | (7, 3) |
| Real Estate Income | (1, 4) | (2, 4) | (3, 4) | (4, 4) | (5, 4) | (6, 4) | (7, 4) |
| Other Rental Income | (1, 5) | (2, 5) | (3, 5) | (4, 5) | (5, 5) | (6, 5) | (7, 5) |
| Interest Income | (1, 6) | (2, 6) | (3, 6) | (4, 6) | (5, 6) | (6, 6) | (7, 6) |
| Ordinary Dividends | (1, 7) | (2, 7) | (3, 7) | (4, 7) | (5, 7) | (6, 7) | (7, 7) |
| Qualified Dividends | (1, 8) | (2, 8) | (3, 8) | (4, 8) | (5, 8) | (6, 8) | (7, 8) |

The datapoints are then stored as extracted document data 2135 for review and exporting. At 1132, the process repeats for the next data group until all data groups are completed and all data fields for the document are saved. At 1134, if there are notes regions, then, at 1136, the associated text is extracted. The operations at 1134-1136 may be repeated for any or all notes regions. At 1138, if there are no more notes regions, then processing returns for a next region at 1108. If, however, there are no additional regions to process at 1138, then at 1140-1142, text extracted from the notes region(s) processed at 1134-1136 is organized and mapped to related data points. After the processing at 1140-1142 is completed, then at 1144, the above processing may be repeated for the next document.

For all text that is applicable to Notes regions, the text is extracted and then organized and summarized using a language processor. The relevant Data Point is identified from the summary, and the organized text is mapped to the Data Point and available for review during the Extracted Data Review process.

### Extracted Data Review

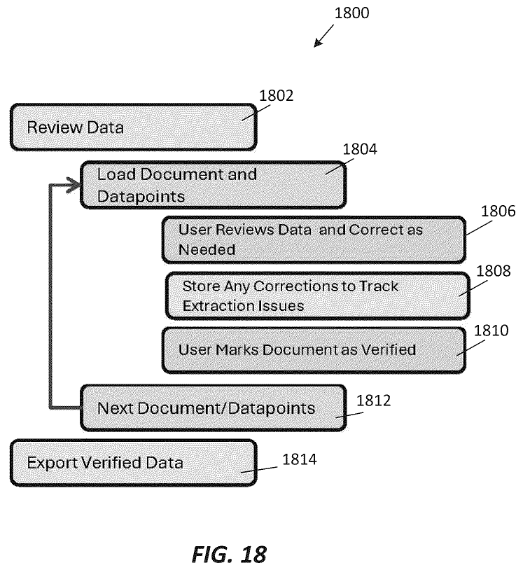

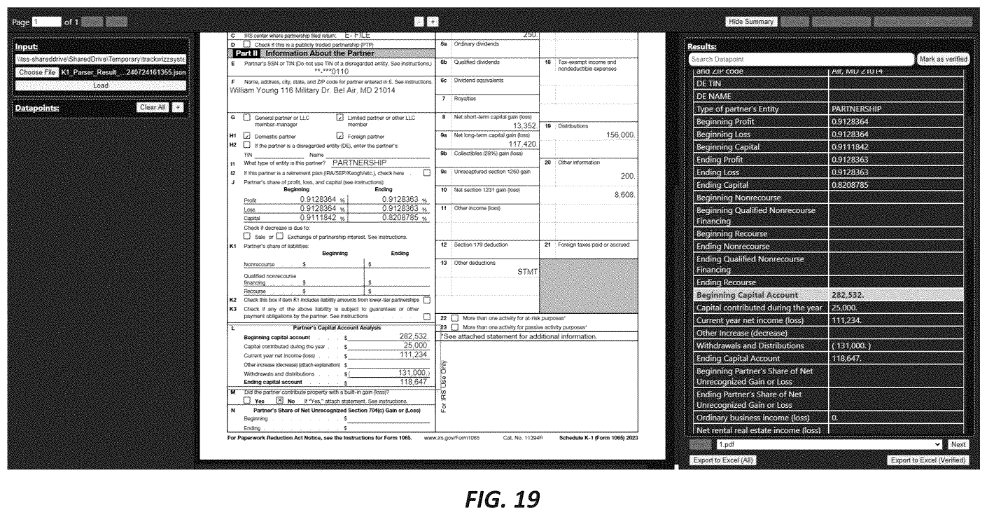

FIG. 18 illustrates an example operational flow diagram of an extracted data review process 1800 according to certain embodiments. After the data has been extracted from one or more documents, the extraction review process 1800 provides an interface (see, FIG. 19) to enable the user to compare the data extracted with the original pdf document.

At 1802, the process to review data begins. At 1804, the document and datapoints are loaded and data is shown in a results table as shown in FIG. 19 for all the extracted datapoints, including text fields, numeric values, matrices and logical elements, such as checkboxes. At 1806, the data is reviewed and marked, if necessary. The review tool highlights the Data Region relating to the selected Data Point. Data may also be flagged for additional review based on various error analyses of expected values that may be applied as part of the review process.

At 1808, any corrections are stored and can be reviewed for future improvements to the Data Extraction Template. At 1810, the document is marked as verified. Upon completion of the review, the user can confirm the data by selecting the “Mark as verified” button. The Method records the completion of the review and retrieves the review screen for the next document. At 1812, the process returns for a next document and the associated datapoints. At 1814, after the data for the batch of Documents has been verified, the data can be extracted into a format suitable for the user's needs.

FIG. 20 illustrates an example matrix and checkbox configuration operational flow diagram 2000 according to certain embodiments that may be implemented at 108 in FIG. 1. At 2002, a matrix schema is created. At 2004-2008, a matrix name and table properties are defined, as well as columns and rows. The elements of the matrix can be further defined by the text values for columns and rows, row and column features and/or by graphical images, such as lines, to delineate the matrix layout. At 2010, a checkbox configuration is created. At 2012, a checkbox configuration name and properties are defined. At 2014, checkbox properties are defined. These may include, but are not limited to, defining a size, shape and/or threshold of pixel darkness that defines a presence (or absence) of a checkmark.

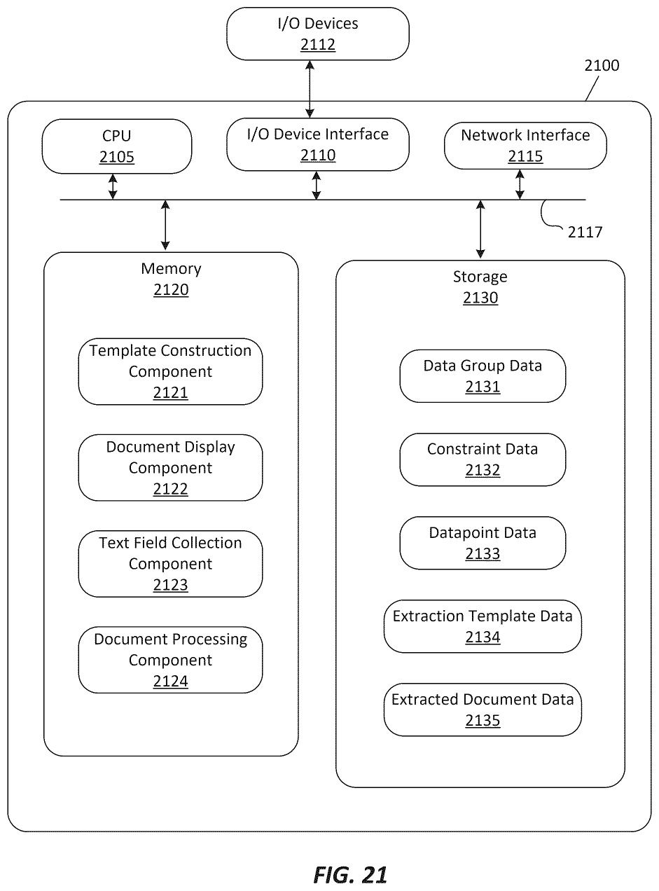

FIG. 21 illustrates examples of computers 2100 that may include the kinds of software programs, data stores, and hardware that can implement event message processing, context determination, notification generation, and content delivery, as described above according to certain embodiments. As shown, the computing system 2100 includes, without limitation, a central processing unit (CPU) 2105, a network interface 2115, a memory 2120, and storage 2130, each connected to a bus 2117. The computing system 2100 may also include an i/o device interface 2110 connecting i/o devices 2112 (e.g., keyboard, display and mouse devices) to the computing system 2100. Further, the computing elements shown in computing system 2100 may correspond to a physical computing system (e.g., a system in a data center) or may be a virtual computing instance executing within a computing cloud.

The CPU 2105 retrieves and executes programming instructions stored in the memory 2120 as well as stored in the storage 2130. The bus 2117 is used to transmit programming instructions and application data between the CPU 2105, I/O device interface 2110, storage 2130, network interface 2115, and memory 2120. Note, CPU 2105 is included to be representative of a single CPU, multiple CPUs, a single CPU having multiple processing cores, and the like, and the memory 2120 is generally included to be representative of a random access memory. The storage 2130 may be a disk drive or flash storage device. Although shown as a single unit, the storage 2130 may be a combination of fixed and/or removable storage devices, such as fixed disc drives, removable memory cards, optical storage, network attached storage (NAS), or a storage area-network (SAN).

Illustratively, the memory 2120 includes one or more of the template construction component 2121, the document display component 2122, the text field collection component 2123 and/or the document processing components 2124, all of which are discussed in greater detail above. Further, storage 2130 includes one or more of, data group data 2131, constraint data 2132, datapoint data 2133, extraction template data 2134 and extracted document data 2135, all of which are also discussed in greater detail above.

It should be understood that the various techniques described herein may be implemented in connection with hardware components or software components or, where appropriate, with a combination of both. Illustrative types of hardware components that can be used include field-programmable gate arrays (FPGAS), application-specific integrated circuits (ASICS), application-specific standard products (ASSPS), system-on-a-chip systems (SOCS), complex programmable logic devices (CPLDS), etc. The methods and apparatus of the presently disclosed subject matter, or certain aspects or portions thereof, may take the form of program code (i.e., instructions) embodied in tangible media, such as removeable drives (floppy diskettes, CD-ROMS), hard drives, including such on cloud-based environments, or any other machine-readable storage medium where, when the program code is loaded into and executed by a machine, such as a computer, the machine becomes an apparatus for practicing the presently disclosed subject matter.

Although certain implementations may refer to utilizing aspects of the presently disclosed subject matter in the context of one or more stand-alone computer systems, the subject matter is not so limited but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for creating an extraction template, comprising:
loading a document into a template construction component;
collecting text fields within the document by a text field collection component to define regions;
repeating the following for each region within the document;
defining a data group region, wherein the data group region comprises constraints of the data group;
defining datapoints in the data group; and
defining processing rules for extracting the datapoints from the region;
exporting the extraction template.

2. The method of claim 1, wherein the constraints comprise boundaries of the data group within a region.

3. The method of claim 1, wherein the region is a rectangular region and four constraints are stored that define a top, a bottom, a left and a right constraint of the rectangular region.

4. The method of claim 1, further comprising displaying the regions on the document that is described by the data group.

5. The method of claim 1, further comprising defining a name for the data group.

6. The method of claim 1, further comprising storing datapoint properties as a regular expression (regex) or graphic image.

7. The method of claim 1, further comprising defining at least one of the datapoints as a matrix that represents a two-dimensional table with columns and rows.

8. The method of claim 7, further comprising defining the columns and the rows by column and row Labels to allow for tables that span multiple pages in the document.

9. The method of claim 1, further comprising defining at least one of the datapoints as a graphical image based on a density of pixels with the defined least one of the datapoints.

10. The method of claim 1, wherein the document is a portable document format (PDF) document.

11. A method for processing a document using an extraction template, comprising:
receiving a selection of the extraction template to apply to a document; and
processing the document by repeating for each data group defined in the extraction template for the document:
identifying constraint text to identify coordinates in the document from using border constraints associated with each data group;
setting a region in the document;
extracting text or image data for the region from the document by passing the region coordinates and the document to a document converter;
parsing text or graphics to extract datapoints in accordance with the data group; and
storing the datapoints.

12. The method of claim 11, wherein the datapoints are data contained within the document.

13. The method of claim 11, further comprising determining at least one of the datapoints as a graphical image.

14. The method of claim 13, wherein the graphical image is a checkbox.

15. The method of claim 11, further comprising determining at least one of the datapoints a matrix having two-dimensions.

16. The method of claim 11, further comprising:
providing a validation user interface to present the datapoints; and
validating the datapoints.

17. The method of claim 11, wherein the document is a portable document format (PDF) document.

18. A non-transitory computer-readable medium having stored thereon instructions for:
loading a document into a template construction component;
collecting text fields within the document by a text field collection component to define regions;
repeating the following for each region within the document;
defining a data group region, wherein the data group region comprises constraints of the data group;
defining datapoints in the data group; and
defining processing rules for extracting the datapoints from the region;
exporting the extraction template.

19. The non-transitory computer-readable medium of claim 18, having further instructions for storing datapoint properties as a regular expression (regex) or graphic image.

20. The non-transitory computer-readable medium of claim 18, having further instructions for: defining at least one of the datapoints as a matrix that represents a two-dimensional table with columns and rows or defining at least one of the datapoints as a graphical image.
